(19) United States
(12) Patent Application Publication
(10) Pub. No.: US 2015/0156483 A1
(43) Pub. Date: Jun. 4, 2015

(54) PROVIDING A CAPABILITY TO SIMULTANEOUSLY VIEW AND/OR LISTEN TO MULTIPLE SETS OF DATA ON ONE OR MORE ENDPOINT DEVICE(S) ASSOCIATED WITH A DATA PROCESSING DEVICE

(71) Applicant: NVIDIA Corporation, Santa Clara, CA (US)

(72) Inventors: Anup Rathi, Satara (IN); Nahush Bhanage, Pune (IN)

(73) Assignee: NVIDIA Corporation, Santa Clara, CA (US)

(21) Appl. No.: 14/094,802

(22) Filed: Dec. 3, 2013

(51) Int. Cl. H04N 13/04; H04N 13/00

(52) U.S. Cl. CPC H04N 13/0447; H04N 13/0429; H04N 13/007; H04N 2213/008

(57) ABSTRACT

A method includes interleaving, through a processor of a data processing device communicatively coupled to a memory and/or a processor of a data source communicatively coupled to the data processing device, each of a data and another data within a data frame. The each of the data and the another data corresponds to a distinct set of video data, image data and/or audio data. The method also includes rendering, through the processor of the data processing device, the data frame on a display unit and/or one or more audio endpoint device(s) associated with the data processing device following the interleaving therewithin, and providing a capability to view and/or listen to solely the data or the another data from the rendered data frame on the display unit and/or the one or more audio endpoint device(s).

### FIELD OF TECHNOLOGY

This disclosure relates generally to data processing devices and, more particularly, to a method, a device and/or a system for providing a capability to simultaneously view and/or listen to multiple sets of data on one or more endpoint device(s) associated with a data processing device.

### BACKGROUND

A data processing device (e.g., a laptop computer, a desktop computer, a server, a notebook computer, a netbook, a smart television) may be coupled to a display unit (e.g., a Liquid Crystal Display (LCD)). Two users of the data processing device may desire to view different video/image content on the display unit at the same time. To address this, a split screen solution may be implemented in the data processing device such that the rendered display data includes desired video/image contents of both the users; obviously, the screen of the display unit may be split therefor. The splitting of the screen space to accommodate multiple video/image contents may distract both the users due to the presence of unwanted content thereof.

In view of the above, a glassless stereo display solution may be implemented, whereby each user may view desired content on the display unit from specific location points known as “sweet spots” defined relative to the display unit. Another glassless stereo solution may involve tracking eyes of the users through one or more sensor(s). As the tracking involves precise values of locations, the movements of the users are restricted. Even if a user moves slightly away from a current location thereof, corruption of the desired video content may be observed by said user. Thus, the aforementioned solutions may not provide for comfortable viewing on part of both the users.

### SUMMARY

Disclosed are a method, a device and/or a system for providing a capability to simultaneously view and/or listen to multiple sets of data on one or more endpoint device(s) associated with a data processing device.

In one aspect, a method includes interleaving, through a processor of a data processing device communicatively coupled to a memory and/or a processor of a data source communicatively coupled to the data processing device, each of a data and another data within a data frame. The each of the data and the another data corresponds to a distinct set of video data, image data and/or audio data. The method also includes rendering, through the processor of the data processing device, the data frame on a display unit and/or one or more audio endpoint device(s) associated with the data processing device following the interleaving therewithin, and providing a capability to view and/or listen to solely the data or the another data from the rendered data frame on the display unit and/or the one or more audio endpoint device(s).

In another aspect, a non-transitory medium, readable through a data processing device and/or a data source communicatively coupled to the data processing device and including instructions embodied therein that are executable through the data processing device and/or the data source, is disclosed. The non-transitory medium includes instructions to interleave, through a processor of the data processing device communicatively coupled to a memory and/or a processor of the data source, each of a data and another data within a data frame. The each of the data and the another data corresponds to a distinct set of video data, image data and/or audio data. The non-transitory medium also includes instructions to render, through the processor of the data processing device, the data frame on a display unit and/or one or more audio endpoint device(s) associated with the data processing device following the interleaving therewithin, and instructions to provide a capability to view and/or listen to solely the data or the another data from the rendered data frame on the display unit and/or the one or more audio endpoint device(s).

In yet another aspect, a data processing system is disclosed. The data processing system includes a memory, a processor communicatively coupled to the memory, a display unit and a pair of glasses, a lens and/or one or more audio endpoint device(s). The processor is configured to execute instructions to interleave each of a data and another data within a data frame. The each of the data and the another data corresponds to a distinct set of video data, image data and/or audio data. The processor is also configured to execute instructions to render the data frame on the display unit and/or the one or more audio endpoint device(s) following the interleaving therewithin. The pair of glasses, the lens and/or the one or more audio endpoint device(s) provides a capability to view and/or listen to solely the data or the another data from the rendered data frame.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a content delivery system, according to one or more embodiments.

FIG. 2 is a schematic and an illustrative view of video data stored in a memory of a client device of the content delivery system of FIG. 1.

FIG. 3 is a schematic and an illustrative view of the video data as including two different sets of video data, each of which is associated with a distinct video sequence, according to one or more embodiments.

FIG. 4 is a process flow diagram detailing the operations involved in providing a capability to simultaneously view and/or listen to multiple sets of data on one or more endpoint device(s) associated with the client device of the content delivery system of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a system and/or a device for providing a capability to simultaneously view and/or listen to multiple sets of data on one or more endpoint device(s) associated with a data processing device. Although the present embodiments have been described with reference to specific example embodiments, it will be evident that various modifications and changes may be made to these embodiments without departing from the broader spirit and scope of the various embodiments.

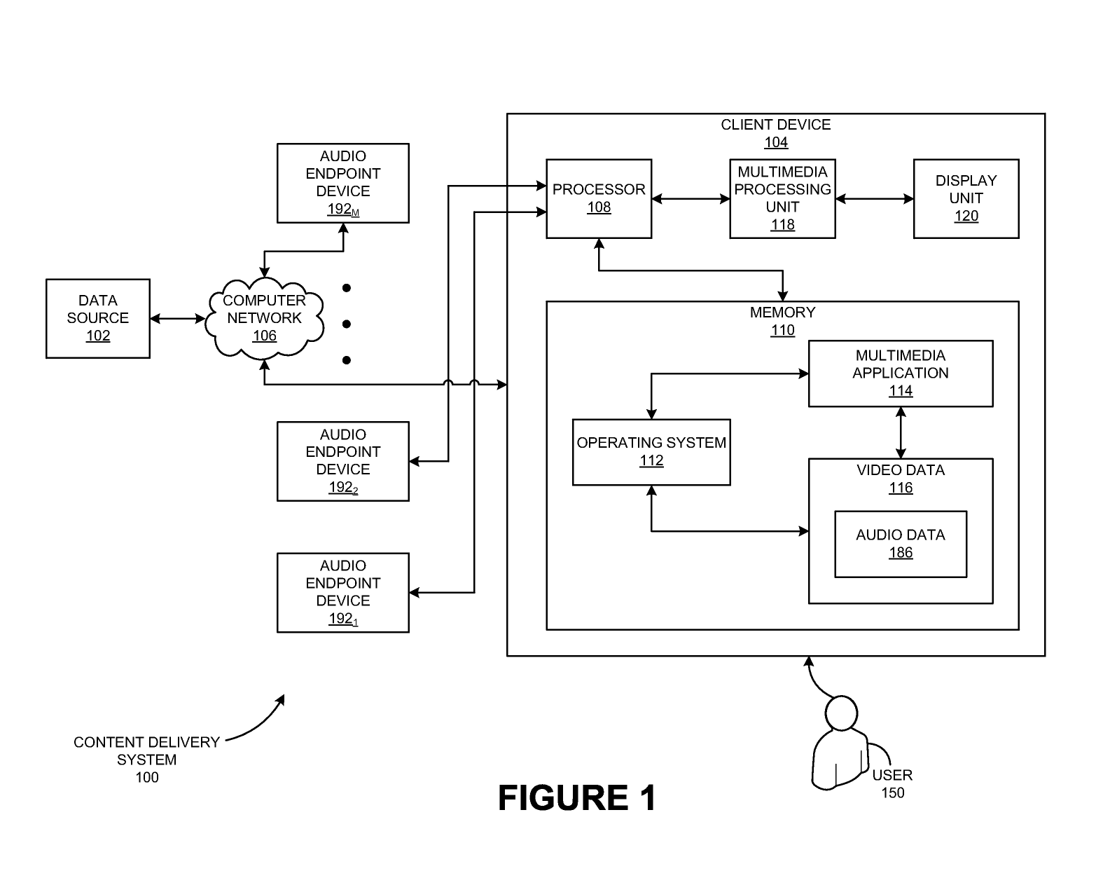

FIG. 1 shows a content delivery system 100, according to one or more embodiments. In one or more embodiments, content delivery system 100 may include a data source 102 (e.g., a server, a computing device) communicatively coupled to one or more client devices (e.g., client device 104) through a computer network 106 (e.g., Internet, a Local Area Network (LAN), a Wide Area Network (WAN)). It is obvious that a single client device 104 is merely shown as an example in FIG. 1. In one or more embodiments, data source 102 may be a server configured to generate real-time data, encode the aforementioned real-time data as video/image data and transmit the video/image data to client device 104 through computer network 106. For example, content delivery system 100 may be a cloud-gaming environment or a video-conferencing environment.

It should be noted that content delivery system 100 is not limited to the cloud-gaming environment or video-conferencing environment mentioned above. For example, data source 102 may also be a mere personal computer transmitting data wirelessly (e.g., through Wi-Fi®, Bluetooth® et al.; based on a home network associated with one or more of the aforementioned communication links) to a tablet (an example client device 104) including a display unit (e.g., a Cathode Ray Tube (CRT) monitor, a Liquid Crystal Display (LCD)). Further, content delivery system 100 is not limited to data transmission through computer network 106. For example, concepts discussed herein may also be applicable to processing associated with files locally stored on, say, client device 104. All example data processing systems having the capability to incorporate concepts discussed herein therein are within the scope of the exemplary embodiments.

FIG. 1 shows client device 104 as including a processor 108 communicatively coupled to a memory 110. Examples of client device 104 may include but are not limited to a laptop computer, a desktop computer, a server, a notebook computer, a netbook, a mobile device such as a mobile phone and a tablet, a smart media player and a smart display. In one or more embodiments, processor 108 may be a Central Processing Unit (CPU), a Graphics Processing Unit (GPU) and/or any dedicated processor configured to execute an appropriate decoding engine thereon (decoding engine may instead be hardware); the dedicated processor may, alternately, be configured to control the appropriate decoding engine executing on another processor. All variations therein are within the scope of the exemplary embodiments. In one or more embodiments, memory 110 may be a volatile memory and/or a non-volatile memory.

It is obvious that an operating system 112 may execute on client device 104. FIG. 1 shows operating system 112 as being stored in memory 110 (e.g., non-volatile memory). In one or more embodiments, client device 104 may execute a multimedia application 114 on processor 108; multimedia application 114 may be configured to render video/image/audio data on an interface thereon. FIG. 1 shows multimedia application 114 as being stored in memory 110 to be executed on processor 108. FIG. 1 also shows video data 116 (and/or image data) to be rendered through multimedia application 114 as also being resident in memory 110 (e.g., volatile memory).

In one or more embodiments, output data associated with processing through processor 108 may be input to a multimedia processing unit 118 configured to perform encoding/decoding associated with the data. In one or more embodiments, the output of multimedia processing unit 118 may be rendered on a display unit 120 (e.g., an LCD display, a CRT monitor, a stereoscopic display, a three-dimensional (3D) display) through a multimedia interface (not shown) configured to convert data to an appropriate format required by display unit 120.

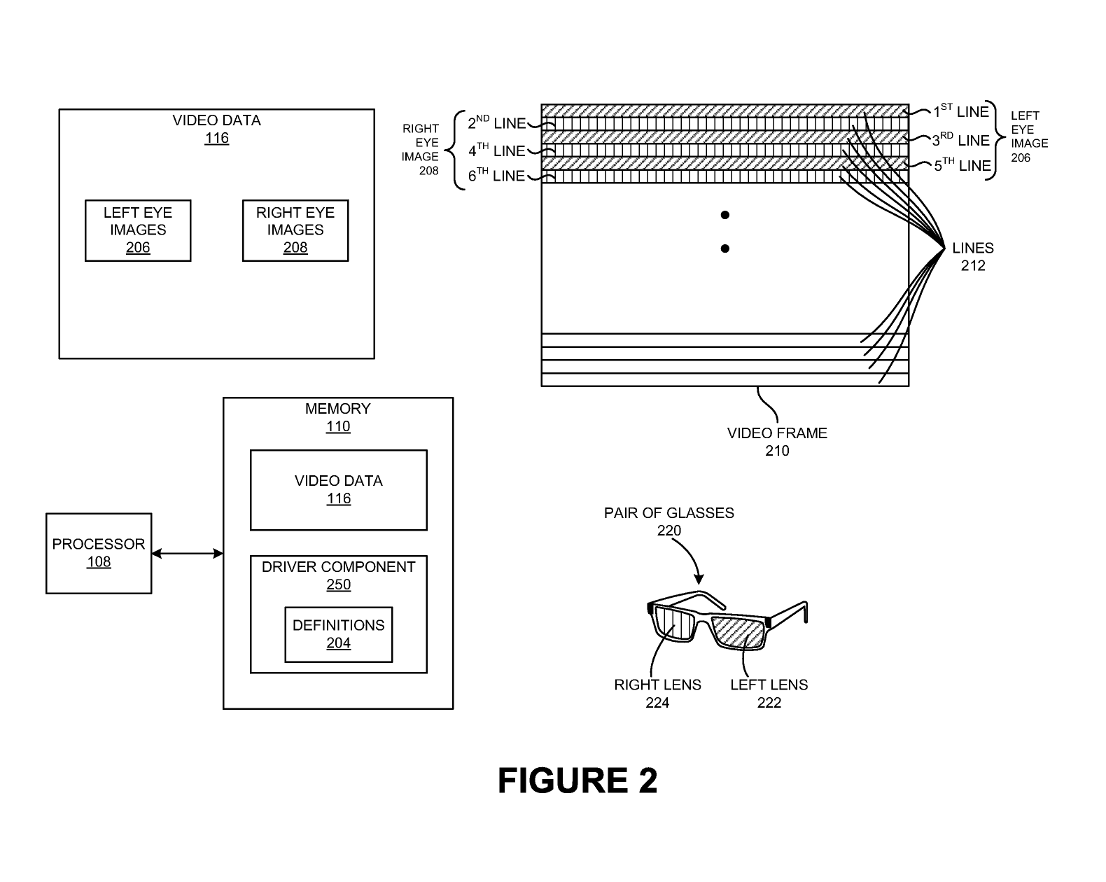

FIG. 2 shows video data 116 stored (e.g., pre-stored, dynamically generated and stored) in memory 110 in detail. Video data 116 may include a number of left eye images 206 and right eye images 208 associated with a video sequence. Here, a driver component 250 (e.g., a set of instructions; shown as stored in memory 110 in FIG. 2) associated with processor 108 may include definitions 204 associated with interleaving a left eye image 206 and a right eye image 208 within a video frame 210 such that left eye image 206 and right eye image 208 alternate with each other as lines 212 therewithin; driver component 250 may trigger execution of appropriate instructions on processor 108 therefor. For example, left eye image 206 may constitute the 1^{st}, 3^{rd}, 5^{th} . . . lines of video frame 210 and right eye image 208 may constitute the 2^{nd}, 4^{th}, 6^{th} . . . lines of video frame 210, as shown in FIG. 2. Following the interleaving, video frame 210 may be rendered on display unit 120. The aforementioned video frame 210 may be viewed with or without special equipment such as glasses (e.g., 3D glasses) and lens. It is obvious that a number of video frames 210 may be rendered on display unit 120 as a video sequence.

In an example implementation, left eye image 206 and right eye image 208 may have an offset corresponding to a distance between a left eye and a right eye of a user 150 of client device 104. In another example implementation, alternate lines 212 of video frame 210 may be polarized to different values so that when viewed through an appropriate pair of glasses 220, a left lens 222 of pair of glasses 220 allows the 1^{st}, 3^{rd}, 5^{th} . . . lines of video frame 210 to pass through and a right lens 224 of pair of glasses 220 allows 2^{nd}, 4^{th}, 6^{th} . . . lines of video frame 210 to pass through.

It should be noted that video frame 210 may instead be encoded with left eye image 206 and right eye image 208 as an interleaved video frame that is part of a video sequence including other video frames 210. Here, processor 108 (or, a hardware decoder) may be configured to decode the interleaved video frame (e.g., video frame 210) prior to rendering thereof on display unit 120. Further, it should be noted that definitions 204 of driver component 250 may not be required; the interleaving may be performed through processor 108 based on executing an appropriate set of instructions (e.g., stored in memory 110).

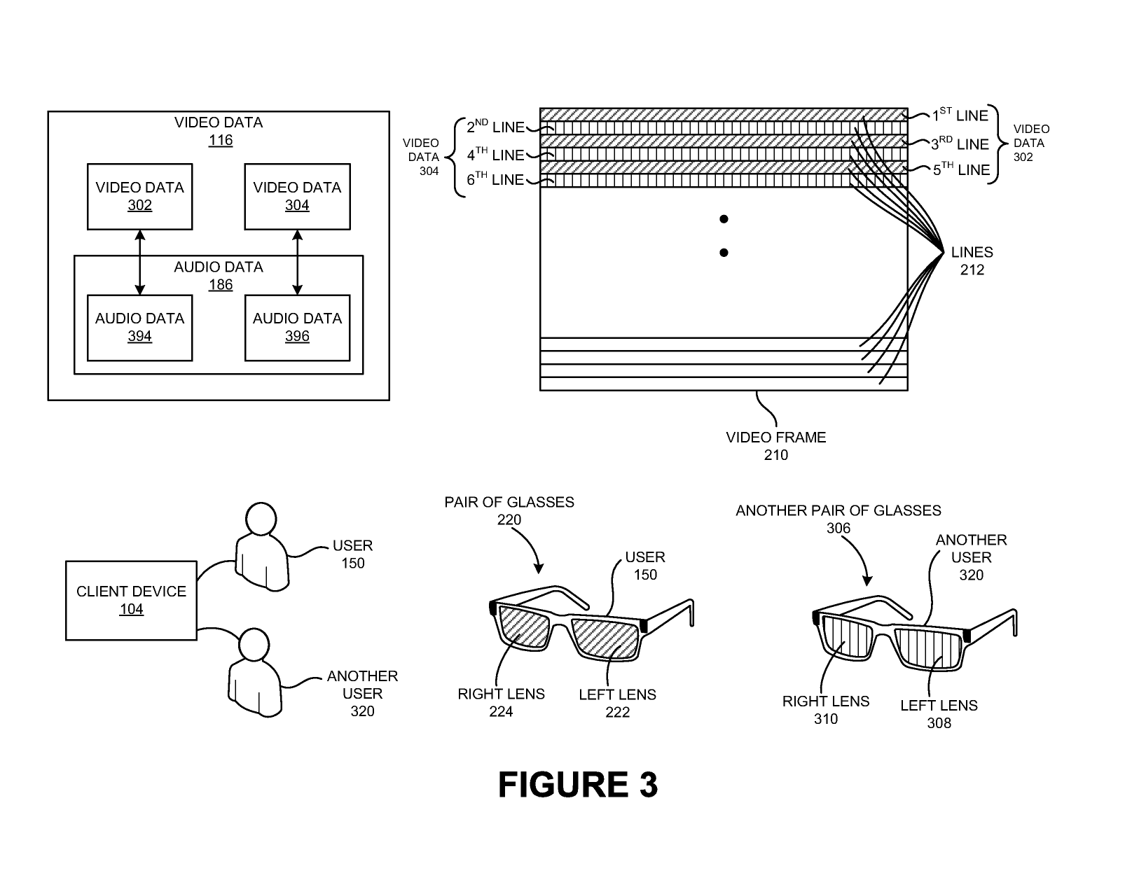

FIG. 3 shows video data 116 as including two different sets of video data (e.g., video data 302 and video data 304), each of which is associated with a distinct video sequence, according to one or more embodiments. In one or more embodiments, definitions 204 of driver component 250 may now be associated with interleaving video data 302 and video data 304 within video frame 210 such that video data 302 and video data 304 alternate with each other as lines 212 therewithin. For example, video data 302 may constitute the 1^{st}, 3^{rd}, 5^{th} . . . lines of video frame 210 and video data 304 may constitute the 2^{nd}, 4^{th}, 6^{th} . . . lines of video frame 210, as shown in FIG. 3. In one or more embodiments, pair of glasses 220 may be modified such that both left lens 222 and right lens 224 thereof may both allow the 1^{st}, 3^{rd}, 5^{th} . . . lines (or, video data 302) of video frame 210 to pass through; pair of glasses 220 may be associated with user 150. Further, in one or more embodiments, another pair of glasses 306 may be provided such that a left lens 308 and a right lens 310 (corresponding to the left eye and the right eye respectively) thereof may both allow the 2^{nd}, 4^{th}, 6^{th} . . . lines (or, video data 304) of video frame 210 to pass through.

In one or more embodiments, another pair of glasses 306 may be associated with another user 320 of client device 104. Thus, in one or more embodiments, each of user 150 and another user 320 of client device 104 may be able to simultaneously view a distinct video sequence through pair of glasses 220 and another pair of glasses 306 respectively. Alternately, the same user (e.g., user 150, another user 320) may view two different video sequences utilizing the same file stored as video data 116 in memory 110 through different pairs of glasses (e.g., pair of glasses 220 and another pair of glasses 306). For example, in one instance, user 150 may view a first video sequence associated with video data 302 within video frames 210 for a duration associated therewith and a second video sequence associated with video data 304 within video frames 210 for the same duration.

In one or more embodiments, video data 116 may also include audio data (e.g., audio data 186 shown as part of video data 116 in FIG. 1) associated therewith. Referring back to FIG. 1, client device 104 may include a number of audio endpoint devices 192₁₋ₘ (e.g., headphones/earphones, speakers, display unit 120 including speakers) associated therewith; for example, one or more audio endpoint device(s) 192₁₋ₘ may be interfaced with a soundcard coupled to a system bus within client device 104, interfaced with a peripheral bus (or, Input/Output (I/O) bus; Universal Serial Bus (USB) may be an example peripheral bus) or coupled to client device 104 through a computer network (e.g., computer network 106). In one or more embodiments, audio data 186 may be configured to be rendered (e.g., through execution of multimedia application 114) on one or more audio endpoint device(s) 192₁₋ₘ.

In the typical scenario discussed above involving left eye image 206 and right eye image 208, audio data 186 may also be appropriately interleaved within video frame 210. The interleaving of audio data 186 may involve sequencing of audio data in proper correspondence with left eye image 206 and right eye image 208. For example, audio data 186 may include audio data associated with left eye image 206 and audio data associated with right eye image 208. Now, user 150 may, for example, employ a pair of speakers (e.g., part of display unit 120) to listen to the audio data associated with left eye image 206 on a left channel speaker and audio data associated with right eye image 208 on a right channel speaker.

In one or more embodiments, when video frame 210 is constituted by video data 302 and video data 304, audio data 186, again, may be appropriately interleaved within video frame 210 such that audio data 186 corresponds to video data 302 and video data 304. As shown in FIG. 3, audio data 186 may include audio data 394 and audio data 396 corresponding to video data 302 and video data 304 respectively. In one or more embodiments, when interleaved video frame 210 is rendered on display unit 120, each of audio data 394 and audio data 396 may also be rendered on distinct one or more audio endpoint device(s) 192₁₋ₘ; the aforementioned distinct one or more audio endpoint device(s) 192₁₋ₘ may be associated with display unit 120; alternately, the one or more audio endpoint devices(s) 192₁₋ₘ on which audio data 394 is rendered may be a pair of speakers and the one or more audio endpoint device(s) 192₁₋ₘ on which audio data 396 is rendered may be another pair of speakers.

It is obvious that user 150 and user 320 may utilize different audio endpoint devices 192₁₋ₘ to listen to audio data 394 and audio data 396 associated with video data 302 and video data 304 respectively. Alternately, in one or more embodiments, the same user (e.g., user 150) may listen to different audio data (394, 396) through the utilization of different audio endpoint devices 192₁₋ₘ.

It is to be noted that the concepts associated with the exemplary embodiments discussed herein are applicable to data solely including audio content (here, audio data may be interleaved within audio frames) or video/image content. Further, as discussed above, exemplary embodiments are also applicable to data including video/image content and audio content.

Still further, it should be noted that the concepts also apply to anaglyph 3D images/video frames where, typically, images corresponding to each eye (left and right eye) of user 150/user 320 may be encoded using filters of different colors (e.g., chromatically opposite colors such as red and cyan). When viewed through appropriate glasses (e.g., red and cyan glasses), the aforementioned images provided for an integrated stereoscopic experience.

In one or more embodiments, video data 302 and video data 304 may be individual anaglyph images interleaved within video frame 210. In one or more embodiments, pair of glasses 220 or another pair of glasses 306 may be utilized to view a video sequence on a two-dimensional (2D) display unit 120; for example, pair of glasses 220 may be red-red glasses utilized to view one video sequence, and another pair of glasses 306 may be cyan-cyan glasses utilized to view another video sequence. Thus, user 150 and user 320 may be able to view different video sequences at the same time. Alternately, again, user 150 or user 320 may be able to view different video sequences through different pairs of glasses.

Exemplary embodiments provide for several advantages. As discussed above, two users (e.g., user 150 and user 320) may be able to watch a different video sequence on client device 104 at the same time. It is obvious that video data 302 and video data 304 may also be different subtitles of a same video sequence. Therefore, user 150 and user 320 may be able to view different subtitles when watching the same video sequence; as the different subtitles may be in different languages, the aforementioned subtitles may be tailored to user requirements. In the case of a presentation, the presenter and the target audience may view different content at the same time.

As each of video data 302 and video data 304 take up the entire screen space on display unit 120, user 150 (and user 320) may not be distracted due to conflicting views as in the case of split screen solutions. User 150 (and user 320) may not be required to adjust a position thereof as in the case of glassless stereo solutions. Also, no costly cameras and sensors performing eye tracking may be required. Similarly, user 150 or user 320 may listen to different audio data at the same time. Also, user 150/320 may not be required to select another audio file through client device 104. User 150/320 may merely need to switch to another one or more audio endpoint device(s) 192₁₋ₘ to listen to a different audio content associated with a same audio file (e.g., including audio data 186).

It should be noted that the interleaving discussed above may not necessarily be performed through client device 104. For example, data source 102 may also perform the interleaving of video data 116/audio data 186, which is accessible (e.g., through computer network 106) through client device 104. Also, it is obvious that more than two sets of video data/audio data may be interleaved within video frames/audio frames to enable more than two users view/listen to content unique thereto. Further, driver component 250 discussed above may be packaged with multimedia application 114 and/or operating system 112 executing on client device 104.

Still further, instructions associated with driver component 250 and/or the interleaving may be embodied in a non-transitory medium (e.g., Compact Disc (CD), Digital Video Disc (DVD), Blu-ray Disc®, hard drive) readable through client device 104 (and/or data source 102) and executable therethrough. Last but not the least, it should be noted that pair of glasses 220/another pair of glasses 306 may be replaced or supplemented with appropriate lens for viewing video content. All reasonable variations are within the scope of the exemplary embodiments discussed herein.

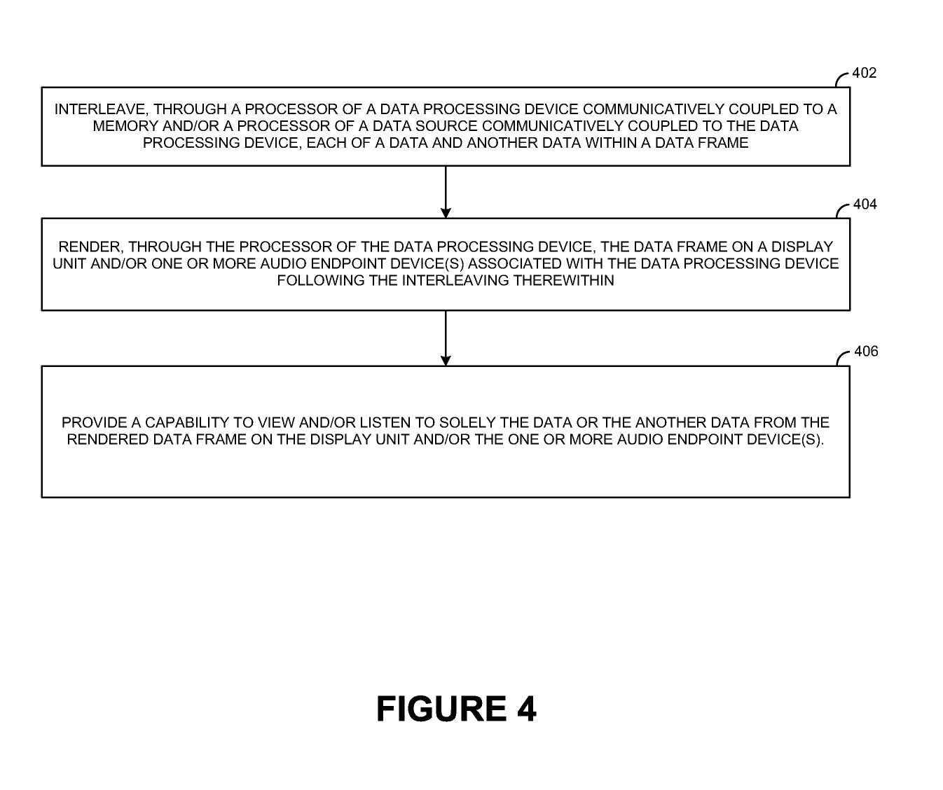

FIG. 4 shows a process flow diagram detailing the operations involved in providing a capability to simultaneously view and/or listen to multiple sets of data on one or more endpoint device(s) associated with client device 104, according to one or more embodiments. In one or more embodiments, operation 402 may involve interleaving, through processor 108 of client device 104 and/or a processor of data source 102 communicatively coupled to client device 104, each of a data (e.g., video data 302) and another data (e.g., video data 304) within a data frame (e.g., video frame 210). In one or more embodiments, the each of the data and the another data may correspond to a distinct set of video data, image data and/or audio data.

In one or more embodiments, operation 404 may involve rendering, through processor 108, the data frame on display unit 120 and/or one or more audio endpoint device(s) 192₁₋ₘ associated with client device 104 following the interleaving therewithin. In one or more embodiments, operation 406 may then involve providing a capability to view and/or listen to solely the data or the another data from the rendered data frame on display unit 120 and the one or more audio endpoint device(s) 192₁₋ₘ.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a data processing device such as client device 104/data source 102). Accordingly, the specification and drawings are to be regarded in an illustrative rather than a restrictive sense.

What is claimed is:

1. A method comprising:
interleaving, through at least one of: a processor of a data processing device communicatively coupled to a memory and a processor of a data source communicatively coupled to the data processing device, each of a data and another data within a data frame, the each of the data and the another data corresponding to a distinct set of at least one of: video data, image data and audio data;
rendering, through the processor of the data processing device, the data frame on at least one of: a display unit and at least one audio endpoint device associated with the data processing device following the interleaving therewithin; and
providing a capability to at least one of: view and listen to solely one of: the data and the another data from the rendered data frame on the at least one of: the display unit and the at least one audio endpoint device.

2. The method of claim 1, comprising providing at least one of: an appropriate pair of glasses and a lens to at least one of: view and listen solely to the one of: the data and the another data from the rendered data frame.

3. The method of claim 1, further comprising defining the interleaving in a driver component associated with the processor of at least one of: the data processing device and the data source.

4. The method of claim 1, wherein when the each of the data and the another data comprises the audio data and at least one of: the video data and the image data, the method further comprises appropriately sequencing the audio data in correspondence with the at least one of: the video data and the image data through the processor of at least one of: the data processing device and the data source.

5. The method of claim 1, comprising interleaving the each of the data and the another data within the data frame as alternating lines thereof when the data frame is at least one of: a video frame and an image.

6. The method of claim 1, comprising providing at least one of:
a distinct anaglyph image as the each of the data and the another data; and
data associated with a distinct subtitle of at least one of: a video frame and an image as the each of the data and the another data.

7. The method of claim 3, comprising providing the driver component packaged with at least one of: an application and an operating system executing on the at least one of: the data processing device and the data source.

8. A non-transitory medium, readable through at least one of: a data processing device and a data source communicatively coupled to the data processing device and comprising instructions embodied therein that are executable through the at least one of: the data processing device and the data source, comprising:
instructions to interleave, through at least one of: a processor of the data processing device communicatively coupled to a memory and a processor of the data source, each of a data and another data within a data frame, the each of the data and the another data corresponding to a distinct set of at least one of: video data, image data and audio data;
instructions to render, through the processor of the data processing device, the data frame on at least one of: a display unit and at least one audio endpoint device associated with the data processing device following the interleaving therewithin; and
instructions to provide a capability to at least one of: view and listen to solely one of: the data and the another data from the rendered data frame on the at least one of: the display unit and the at least one audio endpoint device.

9. The non-transitory medium of claim 8, further comprising instructions to define the interleaving in a driver component associated with the processor of at least one of: the data processing device and the data source.

10. The non-transitory medium of claim 8, wherein when the each of the data and the another data comprises the audio data and at least one of: the video data and the image data, the non-transitory medium further comprises instructions to appropriately sequence the audio data in correspondence with the at least one of: the video data and the image data through the processor of at least one of: the data processing device and the data source.

11. The non-transitory medium of claim 8, comprising instructions to interleave the each of the data and the another data within the data frame as alternating lines thereof when the data frame is at least one of: a video frame and an image.

12. The non-transitory medium of claim 8, comprising instructions compatible with at least one of:
a distinct anaglyph image being provided as the each of the data and the another data; and
data associated with a distinct subtitle of at least one of: a video frame and an image being provided as the each of the data and the another data.

13. The non-transitory medium of claim 9, comprising instructions compatible with the driver component being provided packaged with at least one of: an application and an operating system executing on the at least one of: the data processing device and the data source.

14. A data processing system comprising:
a memory;
a display unit;
at least one of: a pair of glasses, a lens and at least one audio endpoint device; and
a processor communicatively coupled to the memory, the processor being configured to execute instructions to:
interleave each of a data and another data within a data frame, the each of the data and the another data corresponding to a distinct set of at least one of: video data, image data and audio data, and
render the data frame on at least one of: the display unit and the at least one audio endpoint device following the interleaving therewithin,
wherein the at least one of: the pair of glasses, the lens and the at least one audio endpoint device provides a capability to at least one of: view and listen to solely one of: the data and the another data from the rendered data frame.

15. The data processing system of claim 14, further comprising a driver component associated with the processor, the driver component having the interleaving defined therein.

16. The data processing system of claim 14, wherein when the each of the data and the another data comprises the audio data and at least one of: the video data and the image data, the processor is further configured to execute instructions to appropriately sequence the audio data in correspondence with the at least one of: the video data and the image data.

17. The data processing system of claim 14, wherein the processor is configured to execute instructions to interleave the each of the data and the another data within the data frame as alternating lines thereof when the data frame is at least one of: a video frame and an image.

18. The data processing system of claim 14, wherein a distinct anaglyph image is provided as the each of the data and the another data.

19. The data processing system of claim 14, wherein data associated with a distinct subtitle of at least one of: a video frame and an image is provided as the each of the data and the another data.

20. The data processing system of claim 15, wherein the driver component is provided packaged with at least one of: an application and an operating system executing on the data processing system.
